(19) United States
(12) Patent Application Publication
(10) Pub. No.: US 2023/0186905 A1
(43) Pub. Date: Jun. 15, 2023

(54) SYSTEM AND METHOD FOR TONE RECOGNITION IN SPOKEN LANGUAGES

(71) Applicant: FLUENT.AI INC., Montreal (CA)

(72) Inventors: Loren LUGOSCH, Montreal (CA); Vikrant TOMAR, Montreal (CA)

(21) Appl. No.: 18/105,346

(22) Filed: Feb. 3, 2023

Related U.S. Application Data
(63) Continuation of application No. 16/958,378, filed on Jun. 26, 2020.
(60) Provisional application No. 62/611,848, filed on Dec. 29, 2017.

(51) Int. Cl. G10L 15/18; G10L 15/30; G10L 25/15; G10L 25/90

(52) U.S. Cl. CPC G10L 15/1807; G10L 15/30; G10L 25/15; G10L 25/90

(57) ABSTRACT

There is provided a system and method for recognizing tone patterns in spoken languages using sequence-to-sequence neural networks in an electronic device. The recognized tone patterns can be used to improve the accuracy for a speech recognition system on tonal languages.

### CROSS-REFERENCE TO RELATED APPLICATIONS

This application is a continuation of U.S. Pat. Application No. 16/958,378 filed Jun. 26, 2020 which is a national stage filing of International Application No. PCT/CA2018/051682 (International Publication No. WO 2019/126881), filed Dec. 28, 2018, which claims priority to United States Provisional Application No. 62/611,848 filed Dec. 29, 2017. The entire contents of each these applications is incorporated by reference herein.

### TECHNICAL FIELD

The following relates to methods and devices for processing and/or recognizing acoustic signals. More specifically, the system described herein enables recognizing tones in speech for languages where pitch may be used to distinguish lexical or grammatical meaning including inflection.

### BACKGROUND

Tones are an essential component of the phonology of many languages. A tone is a pitch pattern, such as a pitch trajectory, which distinguishes or inflects words. Some examples of tonal languages include Chinese and Vietnamese in Asia, Punjabi in India, and Cangin and Fulani in Africa. In Mandarin Chinese, for example, the words for “mom” ( [symbol] mā), “hemp” ( [symbol] má), “horse” ( [symbol] mă), and “scold” ( [symbol] mà) are composed of the same two phonemes (/ma/) and are distinguishable only through their tone patterns. Consequently, automatic speech recognition systems for tonal languages cannot rely on phonemes alone and must incorporate some knowledge about the tones recognition, whether implicit or explicit, in order to avoid ambiguity. Apart from speech recognition in tonal languages, example embodiments of tone recognition include other uses for automatic tone recognition include large-scale corpus linguistics and computer-assisted language learning.

Tone recognition is a challenging function to implement due to the inter-and intra-speaker variation of the pronunciation of tones. Despite these variations, researchers have found that learning algorithms, such as neural networks, can be used to recognize tones. For instance, a simple multi-layer perceptron (MLP) neural network can be trained to take as input a set of pitch features extracted from a syllable and output a tone prediction. Similarly, a trained neural network can take as input a set of frames of Mel-frequency cepstral coefficients (MFCCs) and output a prediction of the tone of the central frame.

A drawback of existing neural network-based systems for tone recognition is that they require a dataset of segmented speech - that is, speech for which each acoustic frame is labeled with a training target - in order to be trained. Manually segmenting speech is expensive, requires time and significant linguistic expertise. It is possible to use a forced aligner to segment speech automatically, but the forced aligner itself must first be trained on manually segmented data. This is especially problematic for languages for which little training data and expertise is available.

Accordingly, systems and methods that enable tone recognition that can be trained without segmented speech remain highly desirable.

### SUMMARY

In accordance with an aspect there is provided a method of processing and/or recognizing tones in acoustic signals associated with a tonal language, in a computing device, the method comprising: applying a feature vector extractor to an input acoustic signal and outputting a sequence of feature vectors for the input acoustic signal; and applying at least one runtime model of one or more neural networks to the sequence of feature vectors and producing a sequence of tones as output from the input acoustic signal; wherein the sequence of tones are predicted as probabilities of each given speech feature vector of the sequence of feature vectors representing a part of a tone.

In accordance with an aspect the sequence of feature vectors are mapped to a sequence of tones using one or more sequence-to-sequence networks to learn at least one model to map the sequence of feature vectors to a sequence of tones.

In accordance with an aspect the feature vector extractor comprises one or more of a multi-layer perceptron (MLP), a convolutional neural network (CNN), a recurrent neural network (RNN), a cepstrogram computer, a spectrogram computer, a Mel-filtered cepstrum coefficients (MFCC) computer, or a filterbank coefficient (FBANK) computer.

In accordance with an aspect the sequence of output tones can be combined with complimentary acoustic vectors, such as MFCC or FBANK feature vectors or a phoneme posteriorgram, for a speech recognition system that is able to do speech recognition in a tonal language with higher accuracy.

In accordance with an aspect the sequence-to-sequence network comprises one or more of an MLP, a feed-forward neural network (DNN), a CNN, or an RNN, trained using a loss function appropriate to CTC training, encoder-decoder training, or attention training.

In accordance with an aspect an RNN is implemented using one or more of uni-directional or bi-direction GRU, LSTM units or a derivative thereof.

The system and method described can be implemented in a speech recognition system to assist in estimating words. The speech recognition system is implemented on a computing device having a processor, memory and microphone input device.

In another aspect, there is provided a method of processing and/or recognizing tones in acoustic signals, the method comprising a trainable feature vector extractor and a sequence-to-sequence neural network.

In another aspect, there is provided a computer readable media comprising computer executable instructions for performing the method.

In another aspect, there is provided a system for processing acoustic signals, the system comprising a processor and memory, the memory comprising computer executable instructions for performing the method.

In an implementation of the system, the system comprises a cloud-based device for performing cloud-based processing.

In yet another aspect, there is provided an electronic device comprising an acoustic sensor for receiving acoustic signals, the system described herein, and an interface with the system to make use of the estimated tones when the system has outputted them.

### BRIEF DESCRIPTION OF THE DRAWINGS

Further features and advantages of the present disclosure will become apparent from the following detailed description, taken in combination with the appended drawings, in which:

FIG. 1 illustrates a block diagram of a system for implementing tone recognition in spoken languages;

FIG. 2 illustrates a method of using a bidirectional recurrent neural network with CTC, cepstrum-based preprocessing, and a convolutional neural network for tone prediction;

FIG. 3 illustrates an example of the confusion matrix of a speech recognizer which does not use the tone posteriors generated by the disclosed method;

FIG. 4 illustrates an example of the confusion matrix of a speech recognizer which uses the tone posteriors generated by the disclosed method;

FIG. 5 illustrates a computing device for implementing the disclosed system; and

FIG. 6 shows a method for processing and/or recognizing tones in acoustic signals associated with a tonal language.

It will be noted that throughout the appended drawings, like features are identified by like reference numerals.

### DETAILED DESCRIPTION

A system and method is provided which learns to recognize sequences of tones without segmented training data using sequence-to-sequence networks. A sequence-to-sequence network is a neural network trained to output a sequence, given a sequence as input. Sequence-to-sequence networks include connectionist temporal classification (CTC) networks, encoder-decoder networks], and attention networks among other possibilities. The model used in sequence-to-sequence networks is typically a recurrent neural network (RNN); however, not-recurrent architectures also exists, which can be trained a convolutional neural network (CNN) for speech recognition using a CTC-like sequence loss function.

In accordance with an aspect there is provided a method of processing and/or recognizing tones in acoustic signals associated with a tonal language, in a computing device, the method comprising: applying a feature vector extractor to an input acoustic signal and outputting a sequence of feature vectors for the input acoustic signal; and applying at least one runtime model of one or more neural networks to the sequence of feature vectors and producing a sequence of tones as output from the input acoustic signal; wherein the sequence of tones are predicted as probabilities of each given speech feature vector of the sequence of feature vectors representing a part of a tone.

In accordance with another aspect the sequence of feature vectors are mapped to a sequence of tones using one or more sequence-to-sequence networks to learn at least one model to map the sequence of feature vectors to a sequence of tones.

In accordance with an aspect the feature vector extractor comprises one or more of a multi-layer perceptron (MLP), a convolutional neural network (CNN), a recurrent neural network (RNN), a cepstrogram computer, a spectrogram computer, a Mel-filtered cepstrum coefficients (MFCC) computer, or a filterbank coefficient (FBANK) computer.

In accordance with an aspect the sequence of output tones can be combined with complimentary acoustic vectors, such as MFCC or FBANK feature vectors or a phoneme posteriorgram, for a speech recognition system that is able to do speech recognition in a tonal language with higher accuracy.

In accordance with an aspect the sequence-to-sequence network comprises one or more of an MLP, a feed-forward neural network (DNN), a CNN, or an RNN, trained using a loss function appropriate to CTC training, encoder-decoder training, or attention training.

In accordance with an aspect an RNN is implemented using one or more of uni-directional or bi-direction GRU, LSTM units or a derivative thereof.

The system and method described can be implemented in a speech recognition system to assist in estimating words. The speech recognition system is implemented on a computing device having a processor, memory and microphone input device.

In another aspect, there is provided a method of processing and/or recognizing tones in acoustic signals, the method comprising a trainable feature vector extractor and a sequence-to-sequence neural network.

In another aspect, there is provided a computer readable media comprising computer executable instructions for performing the method.

In another aspect, there is provided a system for processing acoustic signals, the system comprising a processor and memory, the memory comprising computer executable instructions for performing the method.

In an implementation of the system, the system comprises a cloud-based device for performing cloud-based processing.

In yet another aspect, there is provided an electronic device comprising an acoustic sensor for receiving acoustic signals, the system described herein, and an interface with the system to make use of the estimated tones when the system has outputted them.

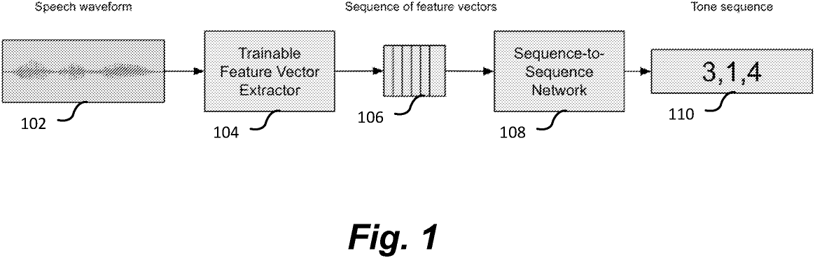

Referring to FIG. 1, the system consists of a trainable feature vector extractor 104 and a sequence-to-sequence network 108. The combined system is trained end-to-end using stochastic gradient-based optimization to minimize a sequence loss for a dataset composed of speech audio and tone sequences. An input acoustic signal such as a speech waveform 102 is provided to the system, the trainable feature vector extractor 104 determines a sequence of feature vectors 106. The sequence-to-sequence network 108 uses the sequence of feature vectors 106 to learn at least one model to map the feature vectors to a sequence of tones 110. The sequence of tones, 110, are predicted as probabilities of each given speech feature vector representing a part of a tone. This can also be referred to as a tone posteriorgram.

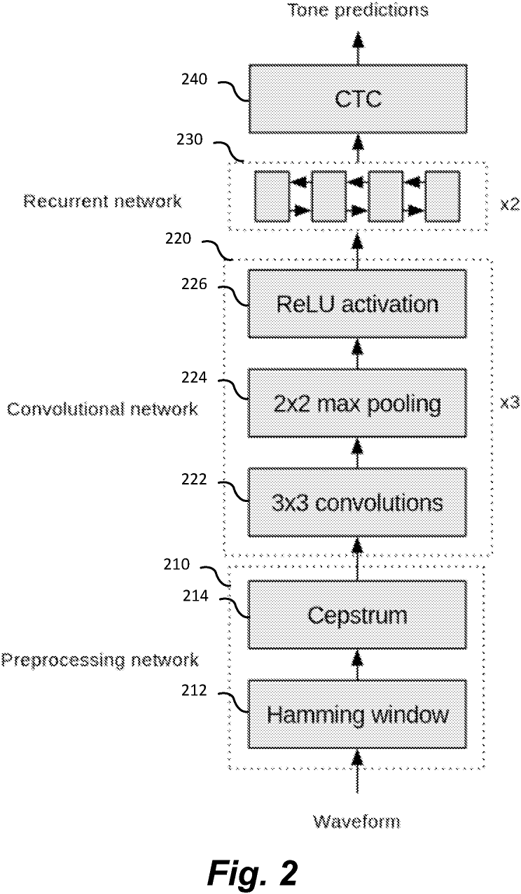

Referring to FIG. 2, in one embodiment, in a preprocessing network 210, the cepstrogram 214 is computed from frames using a Hamming window 212. The cepstrogram 214 is a good choice of input representation for the purpose of tone recognition: it has a peak at an index corresponding to the pitch of the speaker’s voice, and contains all information present in the acoustic signal except for phase. In contrast, F0 features and MFCC features destroy much of the information in the input signal. Alternatively, log Mel-filtered features, also known as filterbank features (FBANK), can also be used instead of the cepstrogram. While the cepstrogram is highly redundant, the trainable feature vector extractor can learn to keep only the information relevant to discrimination of tones. As shown in FIG. 2 the feature extractor 104 can use a CNN 220. The CNN 220 is appropriate for extracting pitch information since a pitch pattern may appear translated over time and frequency. In an example embodiment, a CNN 220 can perform 3×3 convolutions 222 on the cepstrogram then 2×2 max pooling 224 prior to application of a rectified linear unit (ReLU) activation function 226 using a three-layer network. Other configurations of the convolutions (e.g., 2 × 3, 4 × 4 etc), pooling (e.g., average pooling, I2-norm pooling, etc.) and activation layers (e.g., sigmoid, tanh etc.) are also possible.

The sequence-to-sequence network is typically a recurrent neural network (RNN) 230 which can have one or more uni-directional or bi-directional recurrent layers. The recurrent neural network 230 can also have more complex recurrent units such as long-short term memory (LSTM) or gated recurrent units (GRU), etc.

In one embodiment, the sequence-to-sequence network uses the CTC loss function 240 to learn to output the correct tone sequence. The output may be decoded from the logits produced by the network using a greedy search or a beam search.

### EXAMPLE AND EXPERIMENT

An example of the method is shown in FIG. 2. An experiment using this example is performed on the AISHELL-1 dataset as described in Hui Bu, et. al., “AlShell-1: An Open-Source Mandarin Speech Corpus and A Speech Recognition Baseline”, Oriental COCOSDA 2017, 2017 hereby incorporated by reference. AISHELL-1 consists of 165 hours of clean speech recorded by 400 speakers from various parts of China, 47% of whom were male and 53% of whom were female. The speech was recorded in a noise-free environment, quantized to 16 bits, and resampled to 16,000 Hz. The training set contains 120,098 utterances from 340 speakers (150 hours of speech), the dev set contains 14,326 utterances from 40 speakers (10 hours), and the test set contains 7,176 utterances from the remaining 20 speakers (5 hours).

Table 1 lists one possible set of hyper-parameters used in the recognizer for these example experiments. We used a bidirectional gated recurrent unit (BiGRU) with 128 hidden units in each direction as the RNN. The RNN has an affine layer with 6 outputs: 5 for the 5 Mandarin tones, and 1 for the CTC “blank” label.

TABLE 1

Layers of the recognizer described in the experiment

| | |
|---|---|
| Layer type | Hyperparameters |
| framing | 25 ms w/ 10 ms stride |
| windowing | Hamming window |
| FFT | length-512 |
| abs | - |
| log | - |
| IFFT | length-512 |
| conv2d | 11×11, 16 lifters, stride 1 |
| pool | 4×4, max, stride 2 |
| activation | ReLU |
| conv2d | 11×11, 16 lifters, stride 1 |
| pool | 4×4, max, stride 2 |
| activation | ReLU |
| conv2d | 11×11, 16 lifters, stride 1 |
| pool | 4×4, max, stride 2 |
| activation | ReLU |
| dropout | 50% |
| recurrent | BiGRU, 128 hidden units |
| CTC | - |

The network was trained for a maximum of 20 epochs using an optimized, such as for example as disclosed in Diederik Kingma and Jimmy Ba, “Adam: A method for stochastic optimization,” International Conference on Learning Representations (ICLR), 2015 hereby incorporated by reference with a learning rate of 0.001 and gradient clipping. The batch normalization for RNNs and a novel optimization curriculum, called SortaGrad curriculum learning strategy was utilized, described in Dario Amodei, Sundaram Ananthanarayanan, Rishita Anubhai, Jingliang Bai, Eric Battenberg, Carl Case, Jared Casper, Bryan Catanzaro, Qiang Cheng, Guoliang Chen, et al., “Deep Speech 2: End-to-end speech recognition in English and Mandarin,” in 33rd International Conference on Machine Learning (ICML), 2016, pp. 173-182 , in which training sequences are drawn from the training set in order of length during the first epoch and randomly in subsequent epochs. For regularization, and early stopping on the validation set was used to select the final model. To decode the tone sequences from the logits, a greedy search was used.

In an embodiment, the said predicted tones are combined with complimentary acoustic information to enhance the performance of a speech recognition system. Examples of such complimentary acoustic information include a sequence of acoustic feature vectors or a sequence of posterior phoneme probabilities (also known as a phone posteriorgram) obtained via a separate model or set of models, such as a fully connected network, a convolutional neural network, or a recurrent neural network. The posterior probabilities can also be obtained via a joint learning method such as multi-task learning to combined tone as well as phone recognition among other tasks.

An experiment to show that the predicted tones can improve the performance of a speech recognition system was performed. For this experiment, 31 native Mandarin speakers were recorded reading a set of 8 pairs of phonetically similar commands. The 16 commands, as shown in Table 1, were chosen to be phonetically identical except in tones. Two neural networks were trained to recognize this command set: one with phoneme posteriors alone as input, and one with both phoneme and tone posteriors as input.

TABLE 2

Commands used in confusable command experiment

| Index | Transcription in Mandarin characters | Transcription in pinyin | English translation |
|---|---|---|---|
| 0 | [symbol] | “nǐ de xióngmāo” | “your panda” |
| 1 | [symbol] | “nǐ de xiōngmáo” | “your chest hair” |
| 2 | [symbol] | “wǒ kĕyǐ wėn nǐ ma?” | “Can I ask you?” |
| 3 | [symbol] | “wǒ kĕyǐ wĕn nǐ ma?” | “Can I kiss you?” |
| 4 | [symbol] | “wǒ xǐhuān yánjiū” | “I like to study” |
| 5 | [symbol] | “wǒ xǐhuān yān jiŭ” | “I like smoking and drinking” |
| 6 | [symbol] | “shānghài” | “injure” |
| 7 | [symbol] | “Shànghăi” | “Shanghai (city)” |
| 8 | [symbol] | “lăogōng” | “husband” |
| 9 | [symbol] | “láogōng” | “hard labour” |
| 10 | [symbol] | “shīfqu̇” | “lose” |
| 11 | [symbol] | “shíqŭ” | “pick up” |
| 12 | [symbol] | “yèzhŭ” | “owner” |
| 13 | [symbol] | “yĕzhū” | “wild boar” |
| 14 | [symbol] | “shìyán” | “promise” |
| 15 | [symbol] | “shīyán” | “slip of the tongue” |

### Results

The performance of a number of tone recognizers is compared in Table 3. In rows [1]-[5] of the table, other Mandarin tone recognition results reported elsewhere in the literature are provided. In row [6] of the table, the result of the example of the presently disclosed method. The presently disclosed method achieves better results than the other reported results by a wide margin, with a TER of 11.7%.

TABLE 3

Comparison of tone recognition results

| | Method | Model and input features | TER |
|---|---|---|---|
| [1] | Lei et al. [ | HDPF → MLP | 23.8% |
| [2] | Kalinli | Spectrogram → Gabor→ MLP | 21.0% |
| [3] | Huang et al. [ | HDPF → GMM | 19.0% |
| [4] | Huang et al. [ | MFCC + HDPF → RNN | 17.1% |
| [5] | Ryant et al. [ | MFCC → MLP | 15.6% |
| [6] | Present method | CG → CNN → RNN → CTC | 11.7% |

[1] - Xin Lei and Manhung Siu and Mei-Yuh Hwang and Mari Ostendorf and Tan Lee, “Improved tone modeling for Mandarin broadcast news speech recognition.” Proc. of Int. Conf. on Spoken Language Processing, pp. 1237-1240, 2006.
[2] - Ozlem Kalinli, “Tone and pitch accent classification using auditory attention cues,” in ICASSP, May 2011, pp. 5208-5211.
[3] - Hank Huang and Han Chang and Frank Seide, “Pitch tracking and tone features for Mandarin speech recognition,” ICASSP, pp. 1523-1526, 2000.
[4] - Hao Huang and Ying Hu and Haihua Xu, “Mandarin tone modeling using recurrent neural networks,” arXiv preprint arXiv: 1711.01946, 2017.
[5] - Ryant, Neville, Jiahong Yuan, and Mark Liberman, “Mandarin tone classification without pitch tracking,” 2014 IEEE International Conference on Acoustics, Speech and Signal Processing (ICASSP), 2014, pp. 4868-4872.

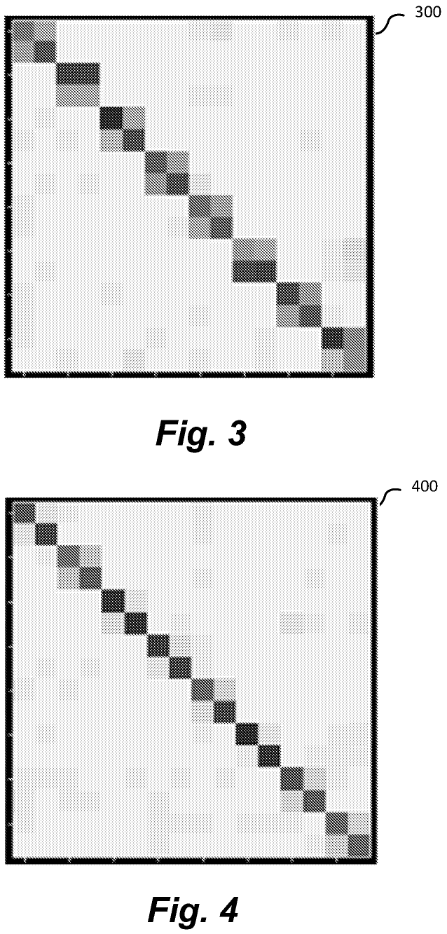

FIG. 3 and FIG. 4 show confusion matrices for the confusable command recognition task in which each pair of consecutive rows represents a pair of similar-sounding commands, and a darker squares indicates higher frequency event (lighter squares indicates few occurrences, darker squares indicates many occurrences). FIG. 3 shows the confusion matrix 300 for the speech recognizer with no tone inputs, and FIG. 4 shows the confusion matrix 400 for the speech recognizer with tone inputs. It is evident from FIG. 3 that relying on phone posteriors alone causes confusion between commands of a pair. Further, by comparing FIG. 3 with FIG. 4 it can be seen that the tone features produced by the proposed method help to disambiguate otherwise phonetically similar commands.

Another embodiment which tone recognition is useful is computer-assisted language learning. Correct pronunciation of tones is necessary for a speaker to be intelligible while speaking a tonal language. In a computer-assisted language learning application, such as Rosetta Stone™ or Duolingo™, tone recognition can be used to check whether the learner is pronouncing the tones of a phrase correctly. This can be done by recognizing the tones spoken by the learner and checking whether they match the expected tones of the phrase to be spoken.

Another embodiment for which automatic tone recognition is useful is corpus linguistics, in which patterns in a spoken language are inferred from large amounts of data obtained for that language. For instance, a certain word may have multiple pronunciations (consider how “either” in English may be pronounced as “IY DH ER” or “AY DH ER”), each with a different tone pattern. Automatic tone recognition can be used to search a large audio database and determine how often each pronunciation variant is used, and in which context each pronunciation is used, by recognizing the tones with which the word is spoken.

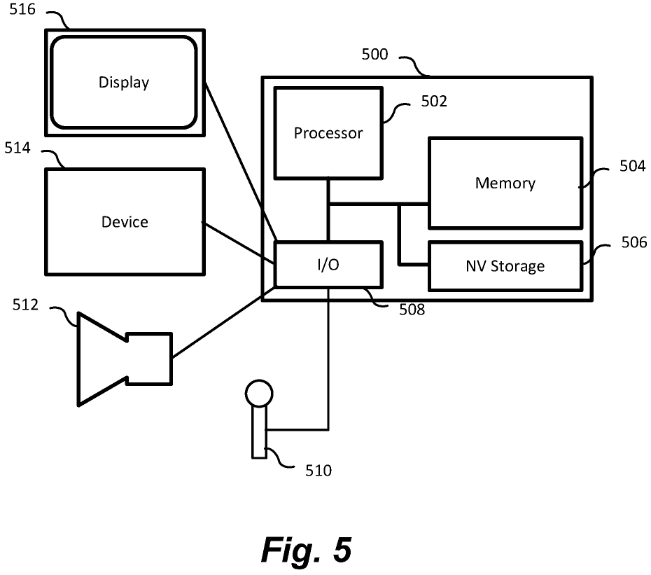

FIG. 5 illustrates a computing device for implementing the disclosed system and method for tone recognition in spoken languages using sequence-to-sequence networks. The system 500 comprises one or more processors 502 for executing instructions from a non-volatile storage 506 which are provided to a memory 504. The processor may be in a computing device or part of a network or cloud-based computing platform. An input/output 508 interface enables acoustic signals comprising tones to be received by an audio input device such as a microphone 510. The processor 502 can then process the tones of a spoken language and using sequence-to-sequence networks. The tones can then be mapped to the commands or actions of an associated device 514, generate output on a display 516, provide audible output 512, or generate instructions to another processor or device.

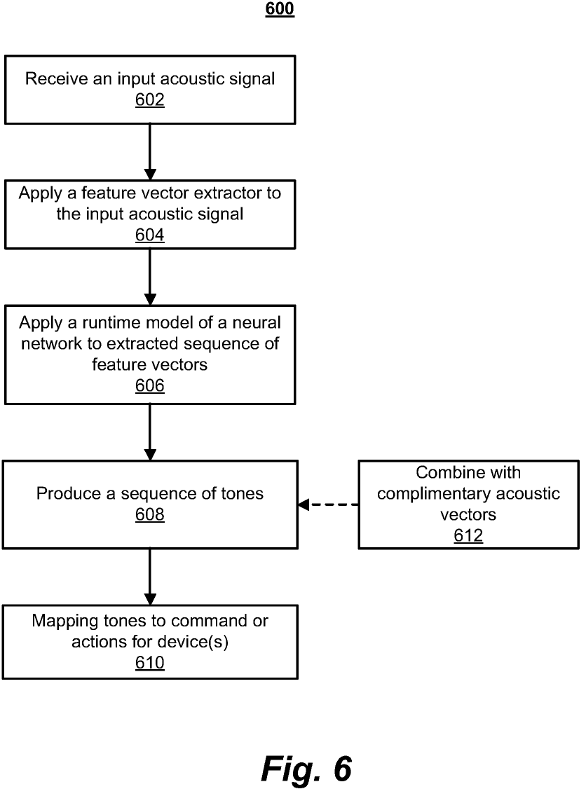

FIG. 6 shows a method 600 for processing and/or recognizing tones in acoustic signals associated with a tonal language. An input acoustic signal is received by the electronic device (602) from an audio input such as microphone coupled to the device. The input may be received from a microphone within the device or located remotely from the electronic device. In addition, the input acoustic signal may be provided from multiple microphone inputs and may be preprocessed for noise cancellation at the input stage. A feature vector extractor is applied to an input acoustic signal and outputting a sequence of feature vectors for the input acoustic signal (604). At least one runtime model of one or more sequence-to-sequence neural networks is applied to the sequence of feature vectors (606) and producing a sequence of tones as output from the input acoustic signal (608). The sequence of tones may optionally be combined with complimentary acoustic vectors to enhance the performance of a speech recognition system (612). The sequence of tones are predicted as probabilities of each given speech feature vector of the sequence of feature vectors representing a part of a tone. The tones having highest probabilities are mapped to commands or actions associated with the electronic device, or a device controlled by or coupled to the electronic device (610). The commands or actions may perform software functions on the device or remote device, perform input into a user interface or application programming interface (API) or result in the execution of commands for performing one or more physical actions by a device. The device may be for example a consumer or personal electronic device, a smart home component, a vehicle interface, an industrial device, an internet of things (IOT) type device or any computing device enable an API to provide data to the device or enable execution of actions of functions on the device.

Each element in the embodiments of the present disclosure may be implemented as hardware, software/program, or any combination thereof. Software codes, either in its entirety or a part thereof, may be stored in a non-transitory computer readable medium or memory (e.g., as a ROM, for example a non-volatile memory such as flash memory, CD ROM, DVD ROM, Blu-ray™, a semiconductor ROM, USB, or a magnetic recording medium, for example a hard disk). The program may be in the form of source code, object code, a code intermediate source and object code such as partially compiled form, or in any other form.

It would be appreciated by one of ordinary skill in the art that the system and components shown in FIGS. 1-6 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

What is claimed is:

1. A method of speech recognition on acoustic signals associated with a tonal language, in a computing device, the method comprising:
applying a feature vector extractor to an input acoustic signal and outputting a sequence of feature vectors for the input acoustic signal;
applying at least one runtime model of one or more neural networks to the sequence of feature vectors and producing a sequence of tones as output from the input acoustic signal;
wherein the sequence of tones are predicted as probabilities of each feature vector of the sequence of feature vectors representing a part of a tone of the sequence of tones;
applying an acoustic model to the input acoustic signal to obtain one or more complimentary acoustic vectors; and
combining the sequence of tones and the one or more complimentary acoustic vectors to output a speech recognition result of the input acoustic signal.

2. The method of claim 1 wherein the sequence of tones define a tone posteriorgram.

3. The method of claim 1 wherein the complimentary acoustic vectors are speech feature vectors or a phoneme posteriorgram.

4. The method of claim 3 wherein the speech feature vectors are provided by one of a Mel-frequency cepstral coefficients (MFCC), a filterbank features (FBANK) technique, or a perceptual linear predictive (PLP) technique.

5. The method of claim 1, further comprising:
mapping the sequence of feature vectors to the sequence of tones using one or more neural networks to learn at least one model to map the sequence of feature vectors to the sequence of tones.

6. The method of claim 1, wherein the feature vector extractor comprises one or more of a multi-layer perceptron (MLP), a convolutional neural network (CNN), a recurrent neural network (RNN), a cepstrogram, a spectrogram, a Mel-filtered cepstrum coefficients (MFCC), or a filterbank coefficient (FBANK).

7. The method of claim 6, wherein the neural network is a sequence-to-sequence network.

8. The method of claim 7 wherein the sequence-to-sequence network comprises one or more of an MLP, a CNN, or an RNN, trained using a loss function appropriate to connectionist temporal classification (CTC) training, encoder-decoder training, or attention training.

9. The method of claim 8 wherein the sequence-to-sequence network has one or more uni-directional or bi-directional recurrent layers.

10. The method of claim 8 wherein when the sequence-to-sequence network is a RNN, the RNN has recurrent units such as long-short term memory (LSTM) or gated recurrent units (GRU).

11. The method of claim 10, where the RNN is implemented using one or more of uni-directional or bi-directional LSTM or GRU units.

12. The method of claim 1 further comprising a preprocessing network for computing frames using a Hamming window providing to define a cepstrogram input representation.

13. The method of claim 12 further comprising a convolutional neural network for performing n x m convolutions on the cepstrogram and then pooling prior to application of an activation layer.

14. The method of claim 13 wherein n=2, 3 or 4 and m=3 or 4.

15. The method of claim 13 wherein pooling comprises 2x2 pooling, average pooling or I2-norm pooling.

16. The method of claim 13 wherein activation layers of the one or more neural networks is one of a rectified linear unit (ReLU) activation function using a three-layer network, a sigmoid layer or a tanh layer.

17. A speech recognition system comprising:
an audio input device;
a processor coupled to the audio input device;
a memory coupled to the processor, the memory for estimating tones present in an input acoustic signal and outputting a sequence of feature vectors for the input acoustic signal by:
applying a feature vector extractor to an input acoustic signal and outputting a sequence of feature vectors for the input acoustic signal;
applying at least one runtime model of one or more neural networks to the sequence of feature vectors and producing a sequence of tones as output from the input acoustic signal, wherein the sequence of tones are predicted as probabilities of each feature vector of the sequence of feature vectors representing a part of a tone of the sequence of tones;
applying an acoustic model to the input acoustic signal to obtain one or more complimentary acoustic vectors; and
combining the sequence of tones and the one or more complimentary acoustic vectors to output a speech recognition result of the input acoustic signal.
